(19) United States
(12) Patent Application Publication
(10) Pub. No.: US 2010/0062292 A1
(43) Pub. Date: Mar. 11, 2010

(54) Fuel Cell system and method for operating the same

(76) Inventors: Jia-Hong Lin, Taipei (TW); Yui-Hsiang Wang, Taipei (TW); Chung-Wen Chih, Taipei (TW)

Correspondence Address: BACON & THOMAS, PLLC, 625 SLATERS LANE, FOURTH FLOOR, ALEXANDRIA, VA, 22314-1176, US

(21) Appl. No.: 12/382,086

(22) Filed: Mar. 9, 2009

(30) Foreign Application Priority Data
Sep. 11, 2008 (TW) 097134819

(51) Int. Cl. H01M 8/04

(52) U.S. Cl. 429/17; 429/20

(57) ABSTRACT

The present invention relates to a fuel cell system and a method for operating the same. The method of the present invention includes: igniting a fuel by an ignition element to generate flames to allow the fuel to carry out an exothermic combustion reaction in a burner, and introducing a reforming reaction material into an evaporator to vaporize the reforming reaction material; transmitting heat generated from the exothermic combustion reaction to a reactor, and introducing the vaporized reforming reaction material into the reactor to perform a reforming reaction and generate hydrogen gas; and introducing the hydrogen gas into a fuel cell stack member to generate electricity. Accordingly, the fuel cell system and the method for operating the same provided by the present invention can reduce start-up time and avoid the additional consumption of electricity.

### BACKGROUND OF THE INVENTION

1. Field of the Invention

The present invention relates to a fuel cell system and a method for operating the same and, more particularly, to a fuel cell system which can reduce start-up time and avoid additional consumption of electricity, and a method for operating the same.

2. Description of Related Art

A fuel cell is an electrochemical conversion device, not an electrical storage device, so the fuel cell is different from ordinary electrochemical cell batteries. The combination of hydrogen and oxygen can produce water and energy, and the energy can be used for the generation of electricity in the fuel cell. Hence, the fuel cell is a device, which can convert chemical energy generated from the combination of hydrogen and oxygen into electrical energy directly. Therefore, the fuel cell can reduce pollution to the environment greatly as compared with an ordinary electrochemical cell, and meet the demands for environmental protection.

A general fuel cell system comprises a reformer and a fuel cell stack. The reformer is used to convert fuels into hydrogen for the fuel cell stack. Then, the fuel cell stack creates electricity through the electrochemical reaction between hydrogen and oxygen. In general, the reformer works at a temperature about 250° C., and a heater connecting to a secondary battery is used to heat the reformer. After the temperature of the reformer has been raised to its working temperature, a hydrogen-generating reaction is performed in the reformer. Finally, the hydrogen, which is not used in the hydrogen-generating reaction, is burned to generate heat to maintain the temperature of the reformer. In addition, when the fuel cell stack used in the fuel cell system is a high-temperature fuel cell, which operates at a temperature of between 120° C. and 180° C., the heat generated from the reformer has to be further transmitted to the fuel cell stack or the fuel cell stack has to be heated by a heater, in order to make the temperature of the fuel cell stack achieve the operating temperature thereof.

Therefore, additional electricity is needed to drive the general fuel cell system, and the process for start-up of the fuel cell system is time-consuming. Especially, as the required power of the fuel cell system increases, the consumption of electricity for start-up correspondingly rises. In addition, this fuel cell system has to be operated with a secondary battery having high capacitance, wherein the secondary battery has the disadvantages of low power and energy density.

Accordingly, it is desirable to provide a fuel cell system, which can reduce the consumption of electricity and time during a start up process.

### SUMMARY OF THE INVENTION

The object of the present invention is to provide a fuel cell system, which can generate heat by combustion, in replacement of electricity, to provide the heat for driving a reforming reaction. Hence, it is possible to reduce the consumption of electricity and time for start-up by the fuel cell system of the present invention.

To achieve the object, the fuel cell system of the present invention includes: a spark-inducing member comprising an ignition element, wherein the ignition element is used for igniting a fuel introduced into the spark-inducing member to generate flames; a reforming reaction member comprising a burner, an evaporator, and a reactor, wherein the burner is connected to the spark-inducing member to receive the fuel to carry out an exothermic combustion reaction in the burner, the evaporator is used to vaporize a reforming reaction material introduced into the evaporator, the reactor is connected to the burner and the evaporator to receive the reforming reaction material provided by the evaporator, and a reforming reaction is carried out in the reactor by the heat generated from the exothermic combustion reaction to generate hydrogen gas; and a fuel cell stack member, which is connected to the reactor of the reforming reaction member to receive the hydrogen provided by the reactor to generate electricity.

Hence, according to the fuel cell system of the present invention, it is possible to supply heat by the combustion reaction to drive a reforming reaction, and no additional consumption of electricity is needed. Therefore, the fuel cell system of the present invention can improve the disadvantages caused by the conventional fuel cell system, which generates heat by electricity.

According to the fuel cell system of the present invention, the spark-inducing member may further comprise a flame block element to prevent the flames from spreading into the burner, in order to improve the safety of the fuel cell system.

According to the fuel cell system of the present invention, the fuel cell stack member can be a low-temperature fuel cell with a working temperature of about 40° C. to 80° C., or a high-temperature fuel cell with a working temperature of about 120° C. to 180° C. When the fuel cell stack member is a high-temperature fuel cell, the fuel cell system of the present invention may further comprise a heat exchange unit, which can provide waste heat in exhaust gas generated from the exothermic combustion reaction to the fuel cell stack member, to raise the temperature of the fuel cell stack member to the working temperature of about 120° C. to 180° C. Hence, the fuel cell system of the present invention can fully utilize the heat generated from the chemical reaction. Accordingly, it is unnecessary to consume additional energy, so it is possible to reduce the consumption of energy for driving the fuel cell system. In addition, the structure of the fuel cell stack member is not particularly limited, and can be any fuel cell stack with known structures. For example, the fuel cell stack member of the present invention may include a cathode, a membrane electrode assembly, and an anode laminated sequentially.

According to the fuel cell system of the present invention, preferably, the flash point of the fuel is under 25° C. Herein, the fuel may be selected from the group consisting of hydrogen, alkane, alkene, alkyne, ether, ketone, and a mixture thereof. Specifically, in the present invention, the fuel may be hydrogen, methane, ethane, propane, butane, pentane, ether, acetone, ethylene, ethyne, or a mixture thereof. Preferably, the fuel is propane, butane, or a mixture thereof.

According to the fuel cell system of the present invention, the reforming reaction material can be any material, which can be used for the hydrogen-generating reaction. For example, it is possible to use methanol and water as a reforming reaction material, wherein the reforming reaction of methanol and water is occurs at a temperature between 200° C. and 300° C. to generate hydrogen gas.

In addition, the fuel cell system of the present invention may further comprise a catalyst for combustion reaction in the burner to catalyze the combustion reaction. Moreover, the fuel cell system of the present invention may further comprise a catalyst for reforming reaction in the reactor to catalyze the reforming reaction.

The present invention further provides a method for operating a fuel cell system, which comprises the following steps: igniting a fuel by an ignition element to generate flames to allow the fuel to undergo an exothermic combustion reaction in a burner, and introducing a reforming reaction material into an evaporator to vaporize the reforming reaction material; transmitting heat generated from the exothermic combustion reaction to a reactor, and introducing the vaporized reforming reaction material into the reactor to perform a reforming reaction and generate hydrogen gas; and introducing the hydrogen gas into a fuel cell stack member to generate electricity.

The method for operating a fuel cell system of the present invention may further comprise: preventing the flame from spreading into the burner by a flame block element after the fuel has been ignited.

In addition, when the fuel cell stack member is a high-temperature fuel cell in the fuel cell system of the present invention, the method for operating the fuel cell system may further comprise: providing a waste heat in exhaust gas generated from the exothermic combustion reaction to the fuel cell stack member by a heat exchange unit.

In conclusion, according to the fuel cell system of the present invention, the heat for the start-up of the reforming reaction can be provided by the combustion reaction, in replacement of electricity. Hence, it is possible to reduce the consumption of electricity and time for driving the fuel cell stack member by the fuel cell system of the present invention.

Other objects, advantages, and novel features of the invention will become more apparent from the following detailed description when taken in conjunction with the accompanying drawings.

### BRIEF DESCRIPTION OF THE DRAWINGS

FIG. 1 is a flowchart showing the operation of the fuel cell system in a preferred embodiment of the present invention; and

FIG. 2 is a flowchart showing the operation of the fuel cell system in another preferred embodiment of the present invention.

### DETAILED DESCRIPTION OF THE PREFERRED EMBODIMENT

### Embodiment 1

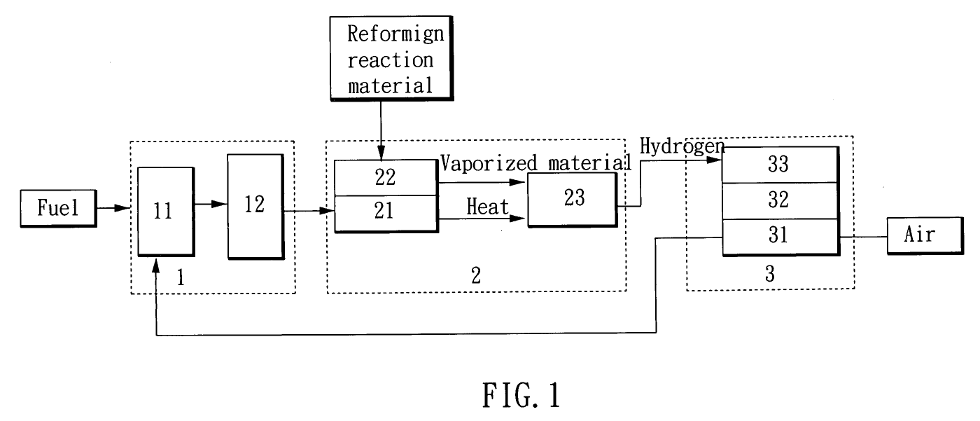

With reference to FIG. 1, it is a flowchart showing the operation of the fuel cell system in the present embodiment.

As shown in FIG. 1, the fuel cell system of the present embodiment comprises: a spark-inducing member 1 comprising an ignition element 11 and a flame block element 12, a reforming reaction member 2 comprising a burner 21, an evaporator 22, and a reactor 23, and a fuel cell stack member 3. In the spark-inducing member 1, the ignition element 11 is used for igniting a fuel introduced into the spark-inducing member 1 to generate flames, and the flame block element 12 is used for preventing the flames from spreading into the burner 21. In the reforming reaction member 2, the burner 21 is connected to the spark-inducing member 1 to receive the fuel to undergo an exothermic combustion reaction in the burner 21, the evaporator 22 is used to vaporize a reforming reaction material introduced into the evaporator 22, the reactor 23 is connected to the burner 21 and the evaporator 22 to receive the reforming reaction material provided by the evaporator 22, and a reforming reaction is carried out in the reactor 23 by the heat generated from the exothermic combustion reaction to generate hydrogen gas. In addition, the fuel cell stack member 3 is connected to the reactor 23 of the reforming reaction member 2 to receive the hydrogen provided by the reactor 23 to generate electricity.

In the present embodiment, the fuel used in the fuel cell system is a mixture of propane and butane; the ignition element 11 is an electrical ignition; a catalyst for the combustion reaction is included in the burner 21 to catalyze the exothermic combustion reaction; the reforming material comprises methanol and water; a catalyst for reforming reaction is included in the reactor 23 to catalyze the reforming reaction; and the fuel cell stack member 3 comprises a cathode 31, a membrane electrode assembly 32, and an anode 33 laminated sequentially. Herein, the fuel cell stack member 3 is a low-temperature fuel cell, which operates at temperature between 40° C. and 80° C.

Accordingly, the method for operating the fuel cell system of the present embodiment is illustrated as follows.

First, with reference to FIG. 1, when the fuel cell system is started, air is introduced therein, followed by the introduction of the fuel into the spark-inducing member 1. Then, the fuel introduced into the spark-inducing member 1 is ignited by the ignition element 11 to generate flames. Herein, the flame block element 12 prevents the flames from spreading into the reforming reaction member 2, and the fuel is introduced into the burner 21 of the reforming reaction member 2. Hence, in the presence of the catalyst for combustion reaction, the exothermic combustion reaction is carried out in the burner 21. Meanwhile, the reforming reaction material is introduced into the evaporator 22 of the reforming reaction member 2 to vaporize the reforming reaction material. Next, the heat generated from the exothermic combustion reaction is transmitted to the reactor 23 of the reforming reaction member 2 to make the temperature of the reactor 23 achieve its operating temperature of about 200° C. to 300° C. Then, the vaporized reforming reaction material is introduced into the reactor 23, and the reforming reaction is performed in the presence of the catalyst for reforming reaction to generate hydrogen gas. Finally, the hydrogen gas generated by the reactor 23 is introduced into the anode 33 of the fuel cell stack member 3 to generate electricity. When the system achieves its balance, the delivery of the fuel can be stopped, and the operating temperature for the reforming reaction can be maintained by the exothermic combustion reaction of the un-reacted reforming gas (hydrogen gas).

### Embodiment 2

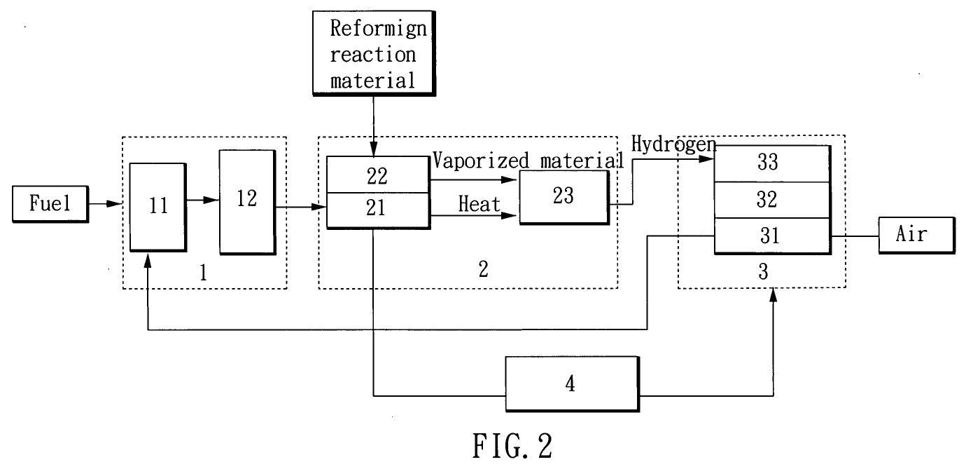

The fuel cell system and the method for operating the same of the present embodiment are each the same as those illustrated in Embodiment 1, except that the fuel cell stack member 3 used in the fuel cell system of the present embodiment is a high-temperature fuel cell, which operates at a temperature from 120° C. to 180° C. Accordingly, with reference to FIG. 2, the fuel cell system of the present invention further comprises a heat exchange unit 4, which can provide a waste heat in exhaust gas generated from the exothermic combustion reaction to the high-temperature fuel cell, to raise the temperature of the fuel cell to its operating temperature.

Although the present invention has been explained in relation to its preferred embodiment, it is to be understood that many other possible modifications and variations can be made without departing from the scope of the invention as hereinafter claimed.

What is claimed is:

1. A fuel cell system, comprising:
a spark-inducing member comprising an ignition element, wherein the ignition element is used for igniting a fuel introduced into the spark-inducing member to generate flames;
a reforming reaction member comprising a burner, an evaporator, and a reactor, wherein the burner is connected to the spark-inducing member to receive the fuel to carry out an exothermic combustion reaction in the burner, the evaporator is used to vaporize a reforming reaction material introduced into the evaporator, the reactor is connected to the burner and the evaporator to receive the reforming reaction material provided by the evaporator, and a reforming reaction is carried out in the reactor by the heat generated from the exothermic combustion reaction to generate hydrogen gas; and
a fuel cell stack member, which is connected to the reactor of the reforming reaction member to receive the hydrogen provided by the reactor to generate electricity.

2. The fuel cell system as claimed in claim 1, wherein the spark-inducing member further comprises a flame block element to prevent the flames from spreading into the burner.

3. The fuel cell system as claimed in claim 1, wherein the flash point of the fuel is under 25° C.

4. The fuel cell system as claimed in claim 3, wherein the fuel is selected from the group consisting of hydrogen, alkane, alkene, alkyne, ether, ketone, and a mixture thereof.

5. The fuel cell system as claimed in claim 3, wherein the fuel is propane, butane, or a mixture thereof.

6. The fuel cell system as claimed in claim 1, further comprising a catalyst for combustion reaction in the burner.

7. The fuel cell system as claimed in claim 1, further comprising a catalyst for reforming reaction in the reactor.

8. The fuel cell system as claimed in claim 1, wherein the fuel cell stack member is a low-temperature fuel cell, which operates at a temperature between 40° C. and 80° C.

9. The fuel cell system as claimed in claim 1, wherein the fuel cell stack member is a high-temperature fuel cell, which operates at a temperature between 120° C. and 180° C.

10. The fuel cell system as claimed in claim 9, further comprising a heat exchange unit, which can provide a waste heat in exhaust gas generated from the exothermic combustion reaction to the fuel cell stack member.

11. A method for operating a fuel cell system, comprising:
igniting a fuel by an ignition element to generate flames to allow the fuel to carry out an exothermic combustion reaction in a burner, and introducing a reforming reaction material into an evaporator to vaporize the reforming reaction material;
transmitting heat generated from the exothermic combustion reaction to a reactor, and introducing the vaporized reforming reaction material into the reactor to perform a reforming reaction and generate hydrogen gas; and
introducing the hydrogen gas into a fuel cell stack member to generate electricity.

12. The method as claimed in claim 11, further comprising:
preventing the flame from spreading into the burner by a flame block element after igniting the fuel.

13. The method as claimed in claim 11, wherein the flash point of the fuel is under 25° C.

14. The method as claimed in claim 13, wherein the fuel is selected from the group consisting of hydrogen, alkane, alkene, alkyne, ether, ketone, and a mixture thereof.

15. The method as claimed in claim 13, wherein the fuel is propane, butane, or a mixture thereof.

16. The method as claimed in claim 11, wherein the exothermic combustion reaction is performed in the presence of a catalyst for combustion reaction.

17. The method as claimed in claim 11, wherein the reforming reaction is performed in the presence of a catalyst for reforming reaction.

18. The method as claimed in claim 11, wherein the fuel cell stack member is a low-temperature fuel cell, which operates at a temperature between 40° C. and 80° C.

19. The method as claimed in claim 13, wherein the fuel cell stack member is a high-temperature fuel cell, which operates at a temperature between 120° C. and 180° C.

20. The method as claimed in claim 19, further comprising:
providing a waste heat in exhaust gas generated from the exothermic combustion reaction to the fuel cell stack member by a heat exchange unit.
